(19) United States
(12) Patent Application Publication
(10) Pub. No.: US 2023/0126787 A1
(43) Pub. Date: Apr. 27, 2023

(54) Image Processing Apparatus, Image Processing System, Authentication Method And Non-Transitory Computer-Readable Recording Medium Encoded With Authentication Program

(71) Applicant: Konica Minolta, Inc., Tokyo (JP)

(72) Inventor: Masaki NAKATA, Toyohashi-shi (JP)

(73) Assignee: Konica Minolta, Inc., Tokyo (JP)

(21) Appl. No.: 17/971,978

(22) Filed: Oct. 24, 2022

(30) Foreign Application Priority Data
Oct. 26, 2021 (JP) 2021-175015
Jul. 15, 2022 (JP) 2022-114120

(51) Int. Cl. H04N 1/44; H04N 1/00; H04L 9/40

(52) U.S. Cl. CPC H04N 1/4413; H04N 1/00244; H04N 1/00344; H04L 63/08; H04N 2201/0094

(57) ABSTRACT

An image processing apparatus is communicable with a service providing server that provides a service, and includes a hardware-processor, wherein the hardware-processor acquires authentication success information representing a successful login to the service in response to an operation input by a user, executes an image process, and sets an operation state to an operable state in which an operation for executing the image process is acceptable in accordance with the authentication success information in response to acquisition of the authentication success information.

This application claims priority to Japanese Patent Application Nos. 2021-175015 filed on Oct. 26, 2021 and 2022-114120 filed on Jul. 15, 2022, the entire disclosures of which are incorporated herein by reference.

### BACKGROUND

### Technological Field

The present invention relates to an image processing apparatus, an image processing system, an authentication method and a non-transitory computer-readable recording medium encoded with an authentication program. In particular, the present invention relates to an image processing apparatus that can utilize a service provided by a server, an information processing system including the image processing apparatus and a management server, an authentication method to be executed by the image processing apparatus, and a computer-readable recording medium encoded with an authentication program for causing a computer controlling the image processing apparatus to execute the authentication method.

### Description of the Related Art

There is a multifunction peripheral (hereinafter referred to as “MFP”) that enables utilization of a service provided by a service providing server connected to the Internet. A user can operate the MFP to cause the service providing server to execute a process. In this case, the authority to operate the MFP is managed by the MFP, and the authority to operate the service provided by the service providing server is managed by the service providing server.

For example, Japanese Patent Application Laid-Open No. 2018-201157 A describes an information processing system, wherein an MFP includes an inputter for inputting registration information, a first transmitter that transmits registration information to a cloud, a first receiver that receives access information that is transmitted from the cloud and is assigned to each MFP, a first storage that stores access information and a first processor that executes a process for accessing the cloud using the access information stored in the first storage, and the cloud includes a second receiver that receives the registration information, a first generator that generates the access information based on the registration information, a second transmitter that transmits the access information to a device, a second storage that stores the access information and a second processor that executes a process for accessing an MFP using the access information stored in the second storage.

However, in the information processing system described in Japanese Patent Application Laid-Open No. 2018-201157 A, it is necessary to store registration information for accessing the cloud in the MFP. Further, the registration information must be transmitted from the MFP to the cloud each time a user logs into the MFP. Therefore, authentication is required in both of the MFP and the cloud, so that a process is complicated.

### SUMMARY

According to one aspect of the present invention, an image processing apparatus that is communicable with a service providing server that provides a service includes a hardware-processor, wherein the hardware-processor acquires authentication success information representing a successful login to the service in response to an operation input by a user, executes an image process, and sets an operation state to an operable state in which an operation for executing the image process is acceptable in accordance with the authentication success information in response to acquisition of the authentication success information.

According to another aspect of the present invention, an information processing system is an information processing system including the above-mentioned image processing apparatus and the management server, and the management server includes a server hardware-processor, wherein the server hardware-processor associates the identification information with the authentication success information in response to a request from the image processing apparatus, and transmits the authentication success information associated with the identification information to the image processing apparatus in response to a requirement from the image processing apparatus.

According to yet another aspect of the present invention, an authentication method that is executed in an image processing apparatus communicable with a server that provides a service, includes acquiring authentication success information representing a successful login to the service in response to an operation input by a user, executing an image process, and setting an operation state to an operable state in which an operation for executing the image process is acceptable in accordance with the authentication success information in response to acquisition of the authentication success information.

According to yet another aspect of the present invention, a non-transitory computer-readable recording medium encoded with an authentication program is executed in a computer that controls an image processing apparatus communicable with a server that provides a service, wherein the authentication program causes the computer to acquire authentication success information representing a successful login to the service in response to an operation input by a user, execute an image process, and set an operation state to an operable state in which an operation for executing the image process is acceptable in accordance with the authentication success information in response to acquisition of the authentication success information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing one example of the overview of an information processing system in a first embodiment of the present embodiment;

FIG. 2 is a block diagram showing one example of the overview of the hardware configuration of an MFP;

FIG. 3 is a diagram showing one example of the functions of a CPU included in the MFP;

FIG. 4 is a flowchart showing one example of a flow of an authentication process in the first embodiment;

FIG. 5 is a flowchart showing one example of a flow of a re-association process in the first embodiment;

FIG. 6 is a flowchart showing one example of a flow of a logout process in the first embodiment;

FIG. 7 is a flowchart showing one example of a flow of a server request process;

FIG. 8 is a diagram showing one example of the functions of a CPU included in an MFP in a modified example;

FIG. 9 is a flowchart showing one example of a flow of an association information transfer process;

FIG. 10 is a diagram showing one example of the overview of an information processing system in a second embodiment;

FIG. 11 is a block diagram showing one example of the overview of the hardware configuration of a management server in the second embodiment;

FIG. 12 is a diagram showing one example of the functions of a CPU included in an MFP in the second embodiment;

FIG. 13 is a block diagram showing one example of the functions of the CPU included in the management server in the second embodiment;

FIG. 14 is a flowchart showing one example of a flow of an authentication process in the second embodiment;

FIG. 15 is a flowchart showing one example of a flow of a re-association process in the second embodiment;

FIG. 16 is a flowchart showing one example of a flow of a logout process in the second embodiment; and

FIG. 17 is a flowchart showing one example of a flow of a server authentication process in the second embodiment.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Thus, a detailed description thereof will not be repeated.

### First Embodiment

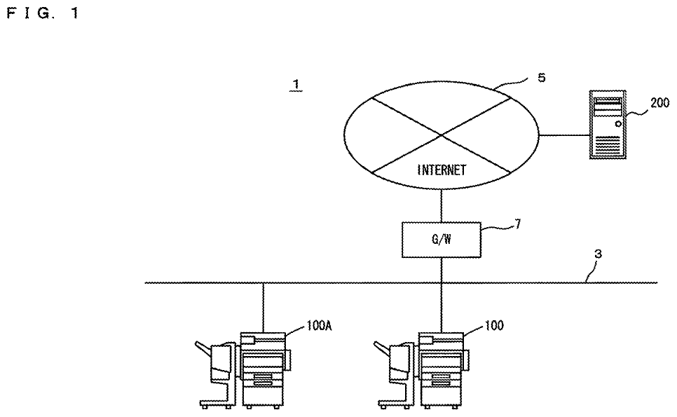

FIG. 1 is a diagram showing one example of the overview of an information processing system in a first embodiment of the present embodiment. With reference to FIG. 1, the information processing system 1 includes MFPs (Multi Function Peripherals) 100, 100A that function as image processing apparatuses and a service providing server 200 that provides services.

The service providing server 200 is connected to the Internet 5. The MFP 100 is connected to a Local Area Network (LAN) 3. The LAN 3 is connected to the Internet 5 via a gateway device 7. Therefore, the MFP 100 can communicate with the service providing server 200.

Although not specified, services to be provided by the service providing server 200 include an image process to be executed with image data as data to be processed, a translation process to be executed with character data as data to be processed, a speech recognition process to be executed with sound data as data to be processed, a speech synthesis process of converting character data into a speech, and the like. The image process includes a character recognition process of recognizing characters in an image, a color converting process of converting colors in an image, and the like. The service providing server 200 is a general computer. Therefore, because the hardware configuration and functions of the service providing server 200 are well known, a description thereof will not be repeated here.

The MFPs 100, 100A have the same hardware configuration and functions. Therefore, the MFP 100 will be described here as an example unless otherwise specified.

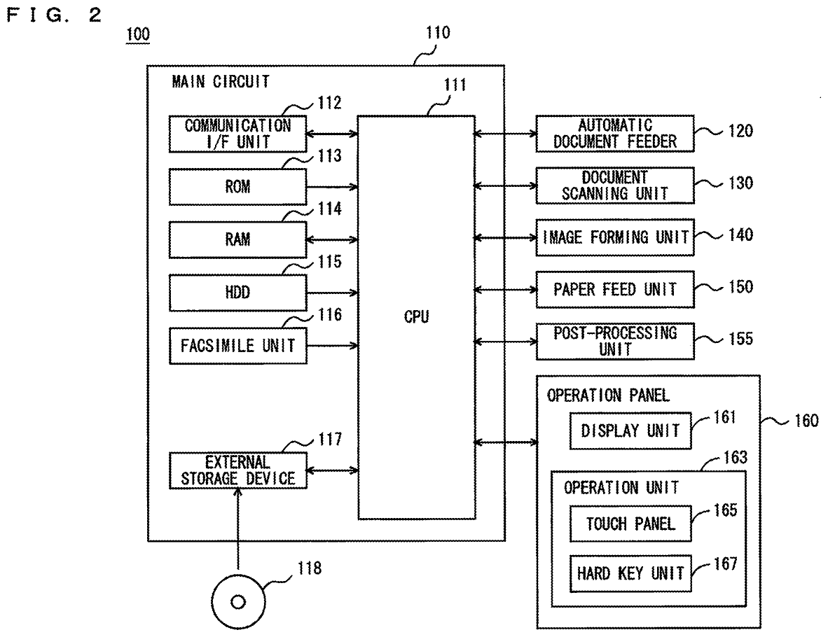

FIG. 2 is a block diagram showing one example of the overview of the hardware configuration of the MFP. With reference to FIG. 2, the MFP 100 includes a main circuit 110, a document scanning unit 130 for scanning a document, an automatic document feeder 120 for conveying a document to the document scanning unit 130, an image forming unit 140 for forming an image on a paper (a sheet of paper) or other media based on image data, a paper feed unit 150 for supplying a paper to the image forming unit 140, a post-processing unit 155 for processing a paper on which an image is formed, and an operation panel 160 serving as a user interface.

The post-processing unit 155 performs a sorting process of sorting and discharging one or more papers on which images are formed by the image forming unit 140, a hole-punching process of punching the papers and a stapling process of stapling the papers.

The main circuit 110 includes a Central Processing Unit (CPU) 201, a communication interface (I/F) unit 112, a ROM (Read Only Memory) 113 for storing a program to be executed by a CPU 111, a RAM (Random Access Memory) 114 to be used as a work area for the CPU 111, a HDD (Hard Disc Drive) 115 for storing data in a non-volatile manner, a facsimile unit 116 and an external storage device 117 on which a CD-ROM (Compact Disk ROM) 118 is mounted. The CPU 111 is connected to the automatic document feeder 120, the document scanning unit 130, the image forming unit 140, the paper feed unit 150, the post-processing unit 155 and the operation panel 160, and controls the MFP 100 as a whole.

The ROM 113 stores a program to be executed by the CPU 111 or data required for execution of the program. The RAM 114 is used as a work area when the CPU 111 executes a program. Further, the RAM 114 temporarily stores scan data (image data) successively sent from the document scanning unit 130.

The operation panel 160 is provided on an upper surface of the MFP 100 and includes a display unit 161 and an operation unit 163. The display unit 161 is a display device such as a liquid crystal display device (LCD) or an organic ELD (Electro-Luminescence Display), and displays an instruction menu for a user, information about acquired image data, and others. The operation unit 163 includes a hard key unit 167 having a plurality of keys, and accepts input data such as each type of an instruction, characters and numerical characters input by user operations corresponding to the keys. The operation unit 163 further includes a touch panel 165 provided on the display unit 161.

The communication I/F unit 112 is an interface for connecting the MFP 100 to the LAN 3. The CPU 111 communicates with a device connected to the LAN 3 via the communication I/F unit 112, and transmits and receives data. Further, the communication I/F unit 112 can communicate with a computer connected to the Internet 5, which is the service providing server 200, for example, via the gateway device 7.

The facsimile unit 116 is connected to the Public Switched Telephone Network (PSTN), transmits facsimile data to the PSTN or receives facsimile data from the PSTN. The facsimile unit 116 stores the received facsimile data in the HDD 115 or outputs the received facsimile data to the image forming unit 140. The image forming unit 140 prints the facsimile data received by the facsimile unit 116 on a paper. Further, the facsimile unit 116 converts the data stored in the HDD 115 into facsimile data and transmits the converted facsimile data to a facsimile machine connected to the PSTN.

The external storage device 117 is mounted with a CD-ROM 118. The CPU 111 can access the CD-ROM 118 via the external storage device 117. The CPU 111 loads a program recorded in the CD-ROM 118, which is mounted on the external storage device 117, into the RAM 114 for execution. It is noted that a medium for storing the program to be executed by the CPU 111 is not limited to the CD-ROM 118. It may be an optical disc (MO (Magnetic Optical Disc)/MD (Mini Disc)/DVD (Digital Versatile Disc)), an IC card, an optical card, and a semiconductor memory such as a mask ROM or an EPROM (Erasable Programmable ROM).

Further, the CPU 111 may load a program stored in the HDD 115 into the RAM 114 for execution. In this case, another computer connected to the LAN 3 or the Internet 5 may rewrite the program stored in the HDD 115 of the MFP 100 or may additionally write a new program therein. Further, the MFP 100 may download a program from another computer connected to the LAN 3 or the Internet 5 and store the program in the HDD 115. The program referred to here includes not only a program directly executable by the CPU 111 but also a source program, a compressed program, an encrypted program and the like.

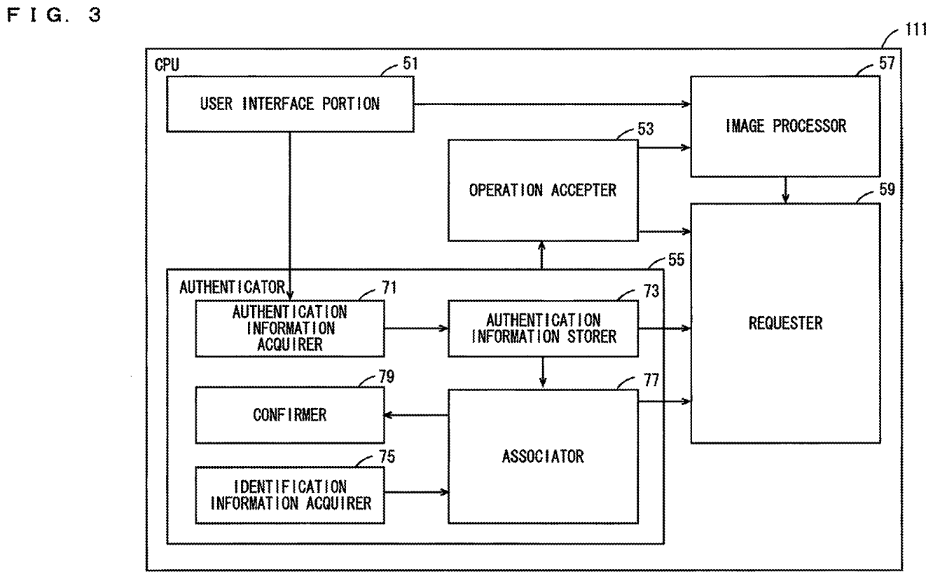

FIG. 3 is a diagram showing one example of the functions of the CPU included in the MFP. The functions shown in FIG. 3 are implemented by the CPU 111 in a case in which the CPU 111 included in the MFP 100 executes an authentication program stored in the ROM 113, the RAM 114, the HDD 115 or the CD-ROM 118A. With reference to FIG. 3, the CPU 111 included in the MFP 100 includes a user interface portion 51, an operation accepter 53, an authenticator 55, an image processor 57 and a requester 59.

The user interface portion 51 is a task for the CPU 111 to execute a browsing program. The browsing program communicates with a computer on the Internet to define a process of displaying a web page stored in the computer and a process of transmitting an operation input by a user with respect to the web page to the computer. A program is not limited to the browsing program as long as it is installed in the MFP 100 to receive a service provided by the service providing server 200. The CPU 111 displays a menu screen for displaying a login screen for logging into a service provided by the service providing server 200 on the display unit 161 with the user not logged into the MFP 100. The menu screen includes options having names of services provided by the service providing server 200, for example. A URL (Uniform Resource Locator) for a service provided by the service providing server 200 and a command for starting the browsing program are assigned to these options. A command is executed in response to acceptance of an operation of designating the option by the operation unit 163, and the browsing program is started. In response to the start of the browsing program, the user interface portion 51 is started.

In response to the start, the user interface portion 51 accesses the URL assigned to the option. Specifically, the user interface portion 51 controls the communication I/F unit 112 to transmit a connection requirement to the service providing server 200 specified by the URL. In response to the connection requirement from the MFP 100, the service providing server 200 transmits a login screen for logging into a service provided by the service providing server 200. The user interface portion 51 displays the login screen on the display unit 161 and waits for the user to input login information to the operation unit 163.

The login information is the information registered in advance in the service providing server 200 in regard to a user who is permitted by the service providing server 200 to use the service. Although not being limited, the login information includes a set of a user ID and a password. In response to acceptance of the login information by the operation unit 163, the user interface portion 51 transmits the login information to the service providing server 200. The service providing server 200 that receives the login information executes an authentication process using the login information. If authentication is successful, the service providing server 200 returns authentication success information to the MFP 100. In a case in which authentication with use of the login information fails, the service providing server 200 returns authentication failure information. The authentication success information becomes valid after authentication is successful in the service providing server 200, and becomes invalid after the user logs out from the service. In other words, the authentication success information is valid only in a period during which the user is logged into the service in the service providing server 200.

The authentication success information includes an ID for identifying the user and a token indicating successful authentication. Further, the authentication success information may be integrated management information with which the ID and the token can be managed at the same time. For example, in case of authentication with use of an SAML (Security Assertion Markup Language) protocol, the authentication success information is referred to as assertion information. The assertion information includes authentication information of the user, an attribute and information describing authority of the user. Further, in case of authentication with use of an OpenID Connect protocol, authentication success information is referred to as an ID token and includes an authentication token or an authorization token. In a case in which the user interface portion 51 is a task for executing the browsing program, authentication success information may be cookie information managed by the user interface portion 51.

In a case in which the communication I/F unit 112 receives authentication success information, the user interface portion 51 displays a web page, which the communication I/F unit 112 subsequently receives from the service providing server 200, on the display unit 161 and transmits an operation input by the user to the operation unit 163 to the service providing server 200. The communication I/F unit 112 may receive a command from the service providing server 200. The command is an API (Application Programming Interface) command for causing the MFP 100 to execute a process, for example. In a case in which the communication I/F unit 112 receives the API command from the service providing server 200, the user interface portion 51 outputs the API command to the image processor 57.

The authenticator 55 authenticates the user who operates the MFP 100. When authentication of the user is successful, the authenticator 55 sets the operation state of the MFP 100 to an operable state. When the user logs out from the MFP 100 after successful authentication of the user, the authenticator 55 sets the operation state to an inoperable state. In other words, the authenticator 55 sets the operation state to the operable state from the time when the authentication of the user is successful to the time when the user logs out from the MFP 100. In a case in which the authentication of the user fails when the operation state is in the inoperable state, the authenticator 55 maintains the inoperable state. The authenticator 55 outputs the operation state to the operation accepter 53. In the MFP 100 in the present embodiment, the authentication process to be executed by the authenticator 55 includes three types of authentication processes: a first authentication process, a second authentication process, and a third authentication process. When authentication is successful in any one of the first authentication process, the second authentication process and the third authentication process, the authenticator 55 sets the operation state to the operable state.

The authenticator 55 includes an authentication information acquirer 71, an authentication information storer 73, an identification information acquirer 75, an associator 77 and a confirmer 79. The authentication information acquirer 71 executes the first authentication process. The authentication information acquirer 71 executes the first authentication process of acquiring authentication success information received by the user interface portion 51 from the service providing server 200. In response to acquisition of the authentication success information by the authentication information acquirer 71, the authenticator 55 sets the operation state of the MFP 100 to the operable state. In a case in which the authentication success information is not acquired by the authentication information acquirer 71, the authenticator 55 determines that authentication of the user has failed.

In response to acquisition of the authentication success information, the authentication information acquirer 71 outputs the authentication success information to the authentication information storer 73 and outputs the operation state indicating the operable state to the operation accepter 53. The authentication information acquirer 71 may acquire the authentication success information from the user interface portion 51, or may monitor the communication I/F unit 112 and acquire the authentication success information, which the communication I/F unit 112 receives from the service providing server 200.

In response to receiving the authentication success information, the authentication information storer 73 stores the authentication success information in a recording medium. The recording medium is the RAM 114, for example. The authentication information storer 73 deletes the authentication success information stored in the recording medium in response to a logout of the user from the MFP 100.

The identification information acquirer 75 acquires identification information input by the user. The identification information includes medium identification information such as a device ID recorded in a card or a portable information device assigned to the user, biometric information of the user and a PIN (Personal Identification Number) assigned to the user. The card includes a magnetic card and an IC card, and stores a card ID as the device ID. The biometric information includes a fingerprint, an iris and a vein pattern. Further, the biometric information may be face authentication information used for face authentication. An identification information reader is provided in the MFP 100. In a case in which the device ID is used as the identification information, the identification information reader is a short-range wireless communication device for performing NFC (Near Field Communication) with a card reader or a portable information device. In a case in which biometric information is used as the identification information, the identification information reader is a fingerprint reader, an iris reader or a vein pattern reader. In a case in which a PIN code is used as the identification information, the identification information reader is the operation unit 163 serving as a code accepter.

In a case in which the identification information is acquired by the identification information acquirer 75, the authenticator 55 executes the second authentication process or the third authentication process based on the identification information. In a case in which authentication of the user is successful when the second authentication process or the third authentication process is executed, the authenticator 55 sets the operation state of the MFP 100 to the operable state. In a case in which authentication of the user is successful when the second authentication process is executed by the authenticator 55, the identification information acquirer 75 outputs the acquired identification information to the associator 77.

In a case in which the identification information is acquired by the identification information acquirer 75 and association information including the identification information is not stored in the HDD 115, the authenticator 55 executes the second authentication process. The second authentication process is a process of authenticating the user in a case in which the same identification information as the identification information acquired by the identification information acquirer 75 is stored in the MFP 100 in advance and not authenticating the user in a case in which the same identification information is not stored in the MFP 100. Although setting the operation state of the MFP 100 to the operable state in a case in which the user is authenticated when the second authentication process is executed, the authenticator 55 sets the operation state of the MFP 100 to the inoperable state in a case in which the user is not authenticated when the second authentication process is executed.

In a case in which authentication success information is stored in the RAM 114 which is a recording medium at a point in time at which the identification information is input, the associator 77 associates the identification information with the authentication success information. Specifically, the associator 77 generates association information including the identification information and the authentication success information and stores the association information in the recording medium. Here, the associator 77 stores the association information in the HDD 115. Further, in a case in which the authentication success information included in the association information becomes invalid, the associator 77 deletes the association information from the recording medium. The associator 77 determines that authentication success information has become invalid in a case in which the user logs out from a service provided by the service providing server 200 or a case in which the service providing server 200 does not execute a process, which the requester 59, described below, requests the service providing server 200 to execute with use of the authentication success information. The association information may include the identification information, and authentication-success-information identification information for identifying the authentication success information.

In a case in which the identification information is acquired by the identification information acquirer 75 and association information including the identification information is stored in the HDD 115, the authenticator 55 executes the third authentication process. In a case in which the association information including the acquired identification information is stored in the HDD 115, the identification information acquirer 75 outputs the authentication success information associated with the identification information by the association information to the confirmer 79.

In a case in which the authentication success information is acquired from the identification information acquirer 75, the confirmer 79 confirms whether the authentication success information is valid. Specifically, the confirmer 79 requests the service providing server 200 that has transmitted the authentication success information to determine whether the authentication success information is valid. For example, the confirmer 79 accesses the service providing server 200 using the authentication success information. In a case in which the authentication success information is valid, the service providing server 200 returns a response to accept the access. In a case in which the authentication success information is not valid, the service providing server 200 returns a response to reject the access. As described above, the authentication success information is valid only in a period during which the user is logged into a service in the service providing server 200. The confirmer 79 confirms whether the authentication success information is valid based on the response of the service providing server 200.

Further, the confirmer 79 may confirm whether the authentication success information is valid by determining whether a communication session established with the service providing server 200 is valid at a point in time at which the user interface portion 51 receives the authentication success information from the service providing server 200. In a period during which the user is logged into a service, the service providing server 200 maintains the communication session which was established in order to transmit the authentication success information issued for the login. Although returning a response in a case in which the communication session is accessed in a period during which the communication session is maintained, the service providing server 200 does not return a response even in a case in which the communication session is accessed after the communication session is disconnected. Therefore, the confirmer 79 accesses the service providing server 200 using the communication session established with the service providing server 200 at a point in time at which the user interface portion 51 receives the authentication success information from the service providing server 200. Then, if there is a response, the confirmer 79 confirms that the authentication success information is valid. If there is no response, the confirmer 79 confirms that the authentication success information is not valid.

In a case in which executing the third authentication process, when confirming that authentication success information is valid, the authenticator 55 stores the authentication success information in the RAM 114 and sets the operation state of the MFP 100 to the operable state. When confirming that the authentication success information is not valid, the authenticator 55 sets the operation state of the MFP 100 to the inoperable state.

In a case in which the first authentication process, the second authentication process or the third authentication process is executed, and authentication of the user is successful, the authenticator 55 sets the operation state to the operable state. When the user logs out, the authenticator 55 sets the operation state to the inoperable state. Further, in a case in which authentication success information is stored in a recording medium when the user logs out, the authenticator 55 deletes the authentication success information. In a case in which association information is stored in a recording medium when the user logs out, the authenticator 55 does not delete the association information.

The operation accepter 53 controls the operation unit 163 and receives an operation input by the user to the operation unit 163. The operation accepted by the operation accepter 53 does not include a user operation of inputting identification information. In a case in which the operation state is set to the operable state by the authenticator 55, the operation accepter 53 outputs an operation accepted by the operation unit 163 to the image processor 57. In a case in which the operation state is set to the inoperable state by the authenticator 55, the operation accepter 53 does not output an operation accepted by the operation unit 163 to the image processor 57.

The image processor 57 controls hardware resources included in the MFP 100 to execute a process. The hardware resources include the automatic document feeder 120, the document scanning unit 130, the image forming unit 140, the paper feed unit 150, the communication I/F unit 112, the HDD 115 and the facsimile unit 116. Therefore, the processes to be executed by the image processor 57 include a scanning process in which the document scanning unit 130 scans a document, an image forming process in which the image forming unit 140 forms an image on a paper supplied from the paper feed unit 150, a data process of storing data in the HDD 115 and a data transmitting-receiving process of controlling the communication I/F unit 112 or the facsimile unit 116 to transmit or receive data. Further, an image process includes a process in which the CPU 111 converts an image in image data. The image process includes a sharpening process of emphasizing an edge of an image, a smoothing process of smoothing an edge of an image, a color conversion process of converting a color and a format conversion process of converting the format of image data. The image processor 57 executes an image process in accordance with an operation received from operation accepter 53.

Further, in response to receiving an API command from the user interface portion 51, the image processor 57 executes a process in accordance with the API command. In a case in which the image processor 57 receives the API command from the user interface portion 51, the user is logged into a service provided by the service providing server 200, and authentication success information is stored in a recording medium by the authentication information storer 73. For example, in a case in which the API command provides an instruction for returning image data that is obtained when a document is scanned, the image processor 57 executes a scan process and executes a data transmission process of transmitting the image data obtained when the document scanning unit 130 scans a document to the service providing server 200 via the communication I/F unit 112.

The requester 59 requests the service providing server 200 to execute a process. The process, which the requester 59 requests the service providing server 200 to execute, is defined by a service provided by the service providing server 200. The requester 59 requests the service providing server 200 to execute a process in accordance with an operation accepted by the operation accepter 53. The requester 59 transmits authentication success information to the service providing server 200 together with a command that defines a process, which the requester 59 requests the service providing server 200 to execute. In a case in which the authentication success information is stored in a recording medium by the authentication information storer 73, the requester 59 transmits the authentication success information to the service providing server 200 together with the command. In a case in which association information is stored in a recording medium even though authentication success information is not stored in the recording medium, the requester 59 transmits the authentication success information included in the association information to the service providing server 200 together with the command.

The process, which the requester 59 requests the service providing server 200 to execute, includes a server process that is linked to a device process executed by the image processor 57. An operation of causing the image processor 57 to execute an image scanning process and an operation of causing the service providing server 200 to process image data that is obtained when the image processor 57 executes the document scanning process are input to the operation accepter 53, by way of example. In this case, the requester 59 transmits the image data obtained when the image processor 57 executes the document scanning process to the service providing server 200 together with authentication success information and a command defining a requested server process.

In a case in which authentication success information is not stored in a recording medium at a point in time at which an operation is accepted by the operation accepter 53, the requester 59 starts the user interface portion 51 and causes the user interface portion 51 to display a login screen for logging into a service provided by the service providing server 200. In a case in which a login to the service provided by the service providing server 200 is successful as a result of this, the authentication information storer 73 stores authentication success information in a recording medium. The requester 59 uses the authentication success information stored in the recording medium by the authentication information storer 73 to request the service providing server 200 to execute a process in accordance with the operation accepted by the operation accepter 53. At this stage, in a case in which authentication of the user has been successful based on identification information acquired by the identification information acquirer 75, and the operation state is set to the operable state, the associator 77 generates association information including the identification information and authentication success information and stores the association information in a recording medium.

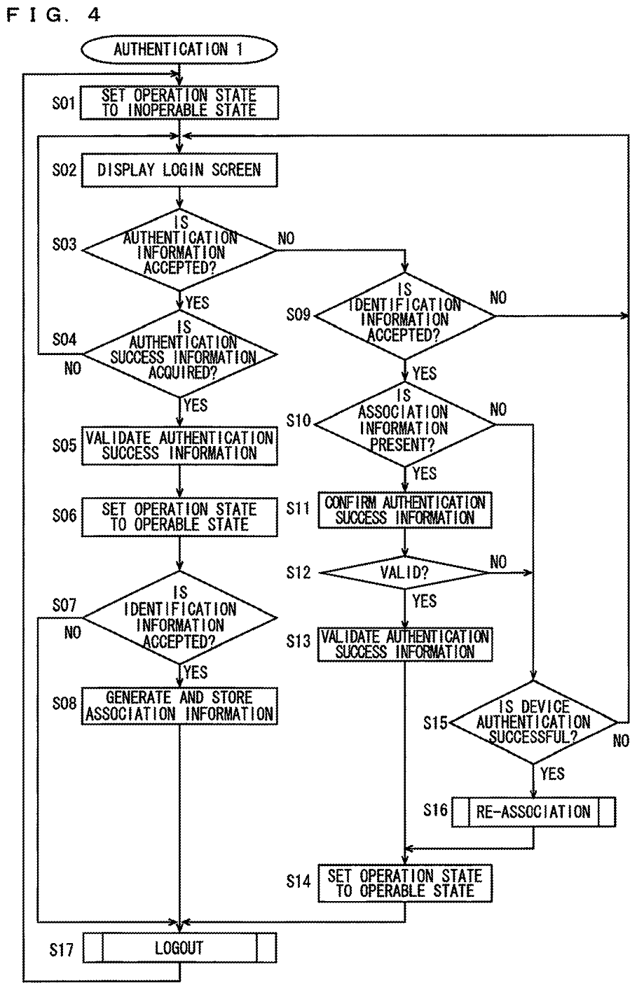

FIG. 4 is a flowchart showing one example of a flow of an authentication process in the first embodiment. The authentication process is a process executed when the CPU 111 included in the MFP 100 executes an authentication program stored in the ROM 113, the RAM 114, the HDD 115 or the CD-ROM 118. With reference to FIG. 4, the CPU 111 included in the MFP 100 sets the operation state to the inoperable state (step S01), and the process proceeds to the step S02. When the operation state is in the inoperable state, an operation for causing the MFP 100 to execute an image process is not accepted. This can prevent a user other than an authenticated user from using the MFP 100.

In the step S02, a login screen is displayed on the display unit 161, and the process proceeds to the step S03. The login screen is a screen for logging into a service provided by the service providing server 200. For example, a menu screen including options for selecting a service provided by the service providing server 200 is displayed on the display unit 161. In a case in which a user operation of designating an option is accepted, a browsing program is started, and the login screen is displayed on the display unit 161.

In the step S03, whether authentication information has been accepted is determined. If the authentication information has been accepted, the process proceeds to the step S04. If not, the process proceeds to the step S09. The authentication information is the information registered in advance in the service providing server 200 as the information representing that the user can receive the service provided by the service providing server 200. In a case in which the authentication information has been accepted, the authentication information is transmitted to the service providing server 200, and the process proceeds to the step S04. The service providing server 200 performs authentication based on the authentication information received from the MFP 100. In a case in which authentication is successful, the service providing server 200 returns authentication success information. If authentication is unsuccessful, the service providing server 200 returns an authentication failure signal.

In the step S04, whether the authentication success information has been acquired is determined. In a case in which the authentication success information is received from the service providing server 200, the process proceeds to the step S05. If not, the process returns to the step S02. In the step S05, the authentication success information is validated, and the process proceeds to the step S06. Here, in a case in which being stored in the RAM 114, the authentication success information is set valid.

In the step S06, the operation state is set to the operable state, and the process proceeds to the step S07. The operable state is a state in which an operation for causing the MFP 100 to execute an image process can be accepted. Therefore, the first authentication process is executed, and the user can operate the MFP 100 to cause the MFP 100 to execute an image process by logging into the service provided by the service providing server 200. In other words, the user can log into the MFP 100 and operate the MFP 100 without performing an operation of inputting identification information to the MFP 100 and only by logging into the service provided by the service providing server 200.

In the step S07, whether identification information has been accepted is determined. If the identification information set for authentication of the user in the MFP 100 is input by the user, the process proceeds to the step S08. If not, the process proceeds to the step S09. In the step S08, association information is generated to be stored in a recording medium, and the process proceeds to the step S17. For example, the association information including the authentication success information acquired in the step S04 and the identification information accepted in the step S07 is stored in the HDD 115.

The process proceeds to the step S09 with the user not logged into the service provided by the service providing server 200 and not logged into the MFP 100. In the step S09, whether the identification information has been accepted is determined. If the identification information set for authentication of the user in the MFP 100 is input by the user, the process proceeds to the step S10. If not, the process returns to the step S03.

In the step S10, whether association information is present is determined. Whether the association information including the identification information accepted in the step S09 is stored in the HDD 115 is determined. If such association information is stored in the HDD 115, the process proceeds to the step S10. If not, the process proceeds to the step S15.

In the step S10, validity of the authentication success information is confirmed, and the process proceeds to the step S12. In the step S12, the process branches depending on whether the authentication success information is valid. If the authentication success information is valid, the process proceeds to the step S12. If not, the process proceeds to the step S15. In a case in which the process proceeds to the step S15, the association information including the identification information accepted in the step S09 is deleted from the HDD 115. This is because invalid authentication success information is unnecessary.

In the step S13, the authentication success information included in the association information is validated, and the process proceeds to the step S14. When being stored in the RAM 114, the authentication success information is set valid. In a case in which the association information is stored in the HDD 115, it is not necessary to authenticate the user in the MFP 100 because authentication of the user has already been successful in the service providing server 200. Therefore, the user can use the service provided by the service providing server 200 without performing an operation of logging into the service provided by the service providing server 200. In other words, the user can use the service provided by the service providing server 200 without performing an operation of logging into the service provided by the service providing server 200 and only by inputting identification information to the MFP 100. Therefore, it is not necessary for the user to input authentication information for authentication in the service providing server 200 to the MFP 100. Further, because the authentication information is not transmitted to the service providing server 200, the MFP 100 does not need to store the authentication information for authentication in the service providing server 200. Therefore, security can be improved.

In the step S14, the operation state is set to the operable state, and the process proceeds to the step S17. The process proceeds from the step S13 in a case in which the third authentication process is executed. Therefore, the user can operate the MFP 100 to cause the MFP 100 to execute an image process.

In the step S15, whether device authentication has been successful is determined. Whether the device authentication has been successful is determined by execution of the second authentication process. Identification information of a user permitted to use the MFP 100 is registered in the MFP 100 in advance. The device authentication is successful in a case in which the identification information accepted in the step S09 is registered in advance in the MFP 100. If the device authentication is successful, the process proceeds to the step S16. If not, the process returns to the step S02. In the step S16, a re-association process is executed, and the process proceeds to the step S14. In the step S14, the operation state is set to the operable state, and the process proceeds to the step S17. The process proceeds from the step S13 in a case in which the second authentication process is executed. Therefore, the user can operate the MFP 100 to cause the MFP 100 to execute an image process.

In the step S17, a logout process is executed, and the process returns to the step S01.

The identification information accepted in the step S07 may be the information for identifying the user. Therefore, the identification information accepted in the step S07 may be different from the identification information registered in the MFP 100 for the device authentication (execution of the second authentication process) in the MFP 100. In this case, in the step S15, the user is required to input the identification information registered in the MFP 100 for the device authentication (execution of the second authentication process) in the MFP 100.

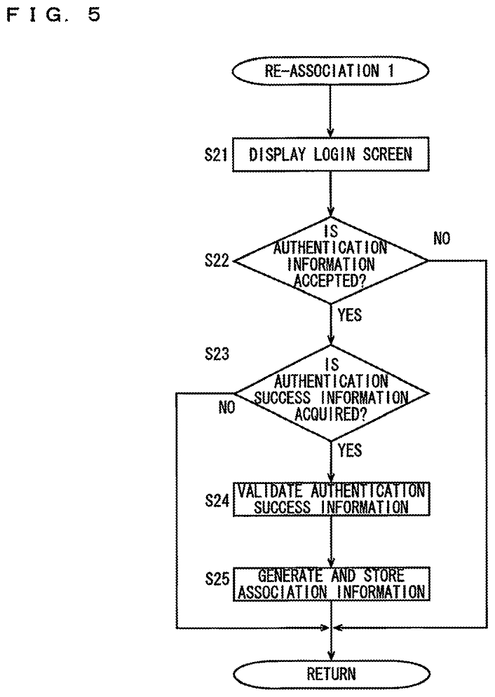

FIG. 5 is a flowchart showing one example of a flow of the re-association process in the first embodiment. The re-association process is a process executed in the step S16 of the authentication process. With reference to FIG. 5, in the step S21, a login screen is displayed on the display unit 161, and the process proceeds to the step S22. The login screen is a screen for logging into a service provided by the service providing server 200. For example, a menu screen including options for selecting a service provided by the service providing server 200 is displayed on the display unit 161. In a case in which a user operation of designating an option is accepted, a browsing program is started, and the login screen is displayed on the display unit 161.

In the step S22, whether authentication information has been accepted is determined. If the authentication information has been accepted, the process proceeds to the step S23. If not, the process returns to the authentication process. The authentication information is the information registered in advance in the service providing server 200 as the information representing that the user can receive the service provided by the service providing server 200. In a case in which the authentication information is accepted, the authentication information is transmitted to the service providing server 200, and the process proceeds to the step S23. The service providing server 200 performs authentication based on the authentication information received from the MFP 100. In a case in which authentication is successful, the service providing server 200 returns authentication success information. If authentication is unsuccessful, the service providing server 200 returns an authentication failure signal.

In the step S23, whether the authentication success information has been acquired is determined. In a case in which the authentication success information is received from the service providing server 200, the process proceeds to the step S24. If not, the process returns to the authentication process. In the step S24, the authentication success information is validated, and the process proceeds to the step S25. Here, the authentication success information is set valid in a case in which the authentication success information is stored in the RAM 114.

In the step S25, association information is generated to be stored in a recording medium, and the process returns to the authentication process. For example, association information including the authentication success information acquired in the step S23 and the identification information accepted in the step S09 of the authentication process is generated to be stored in the HDD 115. Thus, the association information that associates new authentication success information with the identification information is stored in the HDD 115.

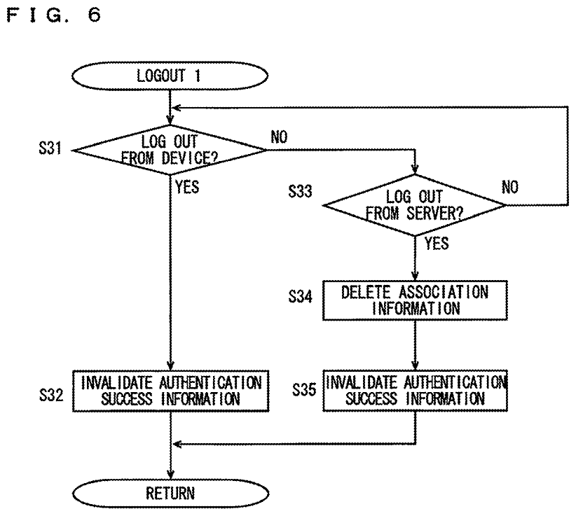

FIG. 6 is a flowchart showing one example of a flow of a logout process in the first embodiment. The logout process is a process executed in the step S17 of the authentication process. With reference to FIG. 6, in the step 31, whether an operation of logging out from a device has been accepted is determined. If the operation of logging out from the MFP 100 has been accepted, the process proceeds to the step S32. If not, the process proceeds to the step S33. Acceptance of the operation of logging out from the device includes detection of a lapse of a predetermined period of time without input of a user operation to the operation unit 163. In the step S32, the authentication success information is invalidated, and the process returns to the authentication process. Here, the authentication success information is set invalid in a case in which the authentication success information is deleted from the RAM 114.

In the step S33, whether the user has logged out from the server is determined. In a case in which the user is logged into the service provided by the service providing server 200, whether the user has logged out from the service is determined. If the user has logged out from the service, the process proceeds to the step S34. If not, the process returns to the step S31. In a case in which the user inputs an operation of logging out to the service providing server 200, the operation is detected.

In the step S34, the association information is deleted, and the process proceeds to the step S35. The association information stored in the HDD 115 is deleted. After logging out from the service provided by the service providing server 200, the authentication success information becomes invalid. Therefore, by deleting the association information including the invalidated authentication success information from the HDD 115, it is possible to prevent the processes subsequent to the step S11 from being executed in a case in which the step S10 is to be executed next in the authentication process. It is possible to prevent the operation state from being set to the operable state based on the authentication success information that has been invalidated for the service provided by the service providing server 200.

In the step S35, the authentication success information is invalidated, and the process returns to the authentication process. Here, the authentication success information is set invalid in a case in which the authentication success information is deleted from the RAM 114.

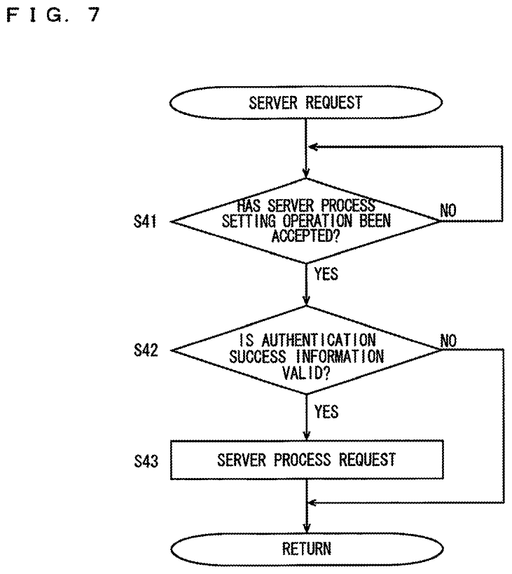

FIG. 7 is a flowchart showing one example of a flow of a server request process. The server request process is a process executed when the CPU 111 included in the MFP 100 executes a browsing program stored in the ROM 113, the RAM 114, the HDD 115 or the CD-ROM 118. With reference to FIG. 7, the CPU 111 included in the MFP 100 determines whether a server process setting operation has been accepted. Whether an operation of setting the contents of a process to be executed by the service providing server 200 in order to use a service provided by the service providing server 200 has been accepted is determined. The CPU 111 waits until such an operation is accepted (NO in the step S01). If the operation is accepted (YES in the step S41), the process proceeds to the step S42.

In the step S42, whether authentication success information is set valid is determined. If the authentication success information is stored in the RAM 114, it is determined that the authentication success information is valid. If the authentication success information is valid, the process proceeds to the step S43. If not, the process ends. In the step S43, execution of a server process is requested, and the process ends. A command for providing an instruction for executing a process defined by the operation accepted in the step S41 and the authentication success information stored in RAM 114 are transmitted to the service providing server 200. The service providing server 200 specifies the user based on the authentication success information received from the MFP 100 and executes the process based on the command. Therefore, the user can use the service provided by the service providing server 200.

### Modified Example

An information processing system 1 in a modified example shares association information with the plurality of MFPs 100, 100A.

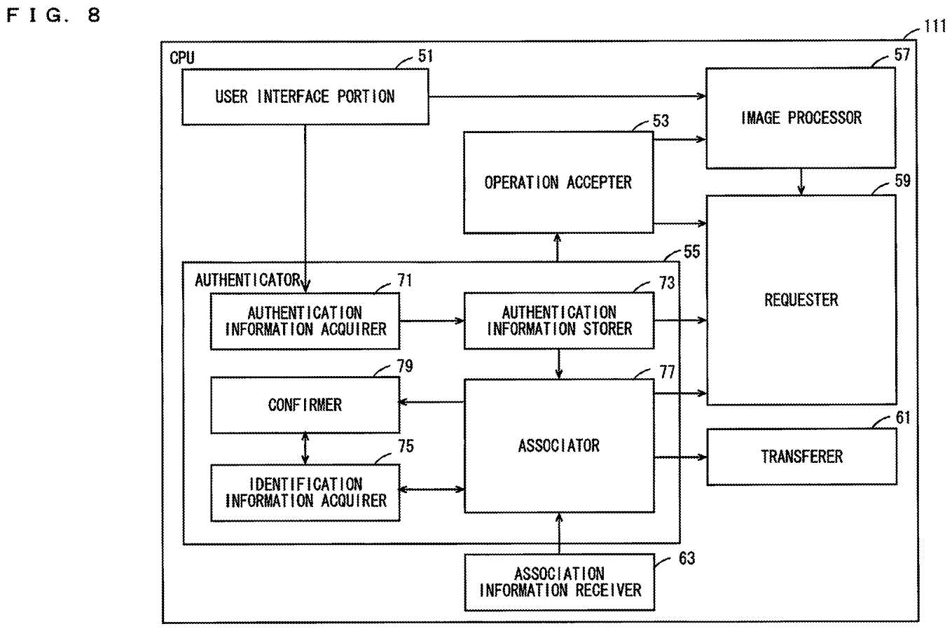

FIG. 8 is a diagram showing one example of the functions of a CPU included in an MFP in the modified example. The functions shown in FIG. 8 are different from the functions shown in FIG. 3 in that a transferer 61 and an association information receiver 63 are added. The other functions are the same as the functions shown in FIG. 3. A description therefore will not be repeated.

In response to storage of association information in a recording medium by the associator 77, the transferer 61 transmits the association information to another image processing apparatus, which is the MFP 100A in this case. The MFP 100A is preferably a predetermined device in the MFP 100. It is possible to enhance security by restricting a device to which the association information is to be transmitted. Further, the transferer 61 may transmit the association information to the MFP 100A in response to receiving a requirement from the MFP 100A.

The association information receiver 63 receives the association information from another image processing apparatus, which is the MFP 100A in this case. In response to receiving the association information from the MFP 100A, the association information receiver 63 outputs the association information to the associator 77. The associator 77 stores the association information received from the association information receiver 63 in the HDD 115. Therefore, when the user logs into a service provided by the service providing server 200 in the MFP 100A and then inputs identification information to the MFP 100A, association information generated in the MFP 100A is stored in the MFP 100. When logging out from the MFP 100A without logging out from the service provided by the service providing server 200 and then logging into the MFP 100 using the identification information, the user can use the service provided by the service providing server 200 without logging into the service provided by the service providing server 200.

In a case in which the association information including the identification information is not stored in the HDD 115 at a point in time at which the identification information is received, the association information receiver 63 may require the MFP 100A to transmit the association information.

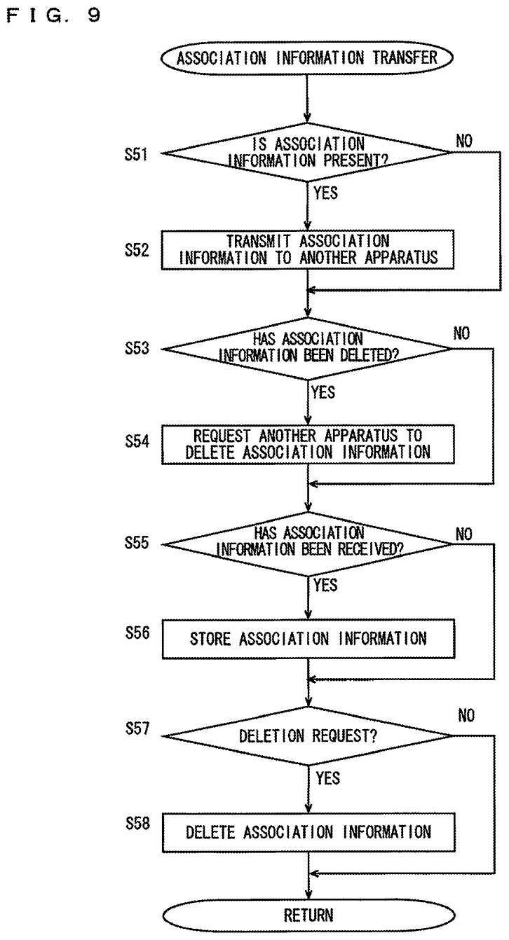

FIG. 9 is a flowchart showing one example of a flow of an association information transfer process. The association information transfer process is a process executed by the CPU 111 when the CPU 111 included in the MFP 100 executes an authentication program stored in the ROM 113, the RAM 114, the HDD 115 or the CD-ROM 118. With reference to FIG. 9, the CPU 111 included in the MFP 100 determines whether association information is present (step S51). If association information is stored in the HDD 115, the process proceeds to the step S52. If not, the process proceeds to the step S53. In the step S52, the association information is transmitted to another apparatus, and the process proceeds to the step S53. The association information is transmitted to the MFP 100A in this case. The other apparatus device may be a predetermined device.

In the step S53, whether the association information has been deleted is determined. If the association information stored in the HDD 115 has been deleted, the process proceeds to the step S54. If not, the process proceeds to the step S55. In the step S54, an association information deletion request is transmitted to the other apparatus, and the process proceeds to the step S55. The association information deletion request includes information for identifying the association information. The information for identifying the association information is identification information included in the association information, for example.

In the step S55, whether the association information has been received from the other apparatus is determined. If the association information has been received, the process proceeds to the step S56. If not, the process proceeds to the step S57. In the step S56, the received association information is stored in the HDD 115, and the process proceeds to the step S57.

In the step S57, whether a deletion request has been received from the other apparatus is determined. If the deletion request has been received, the process proceeds to the step S58. If not, the process ends. The association information specified by the deletion request is deleted in the step S58, and the process ends. The association information including the same identification information as the identification information included in the deletion request is deleted from the HDD 115.

### Other Modified Examples

Although the service providing server 200 issues authentication success information, by way of example, in the above-mentioned embodiment, the authentication success information may be issued by a computer different from the service providing server 200, for example, an authentication server. In this case, the MFP 100 transmits authentication information to the authentication server and requests the authentication server to perform authentication. In a case in which the authentication based on the authentication information is successful, the authentication server returns authentication success information to the MFP 100. In a case in which the authentication is successful in the authentication server, the authentication success information issued by the authentication server with respect to the user of the MFP 100 is acquired by the service providing server 200. In a case in which the MFP 100 requires provision of a service together with the authentication success information issued by the authentication server, the service providing server 200 determines that the user of the MFP 100 is an authentic user based on the authentication success information and provides the required service.

As described above, in the information processing system 1 in the first embodiment, the MFP 100 functions as an image processing apparatus, includes the user interface portion 51 for operating the service providing server 200 that provides services, acquires authentication success information that is issued in response to a successful login to a service by the service providing server 200 operated by the user or the authentication server associated with the service providing server and sets the operation state to the operable state in which an operation for executing an image process is acceptable in accordance with the authentication success information. Therefore, the successful login to the service provided by the service providing server 200 enables the MFP 100 to execute the image process. Because device authentication (execution of the second authentication process) in the MFP 100 is not required, a user operation for authentication is simplified.

Further, the MFP 100 transmits the authentication success information to the service providing server 200 in order to cause the service providing server 200 to provide the service. Therefore, it is possible to cause the service providing server 200 to provide the service in regard to the process to be executed by the MFP 100.

Further, the MFP 100 associates identification information that is accepted in a period during which the operable state is set with the authentication success information, and sets the operation state to the operable state in a case in which the identification information that is accepted in a period during which the inoperable state is set is associated with the authentication success information. Therefore, after the login to the service is authenticated and the user inputs the identification information in a period during which the operable state is set, in a case in which the user inputs the identification information during the inoperable state, the operation state is set to the operable state, and the service can be provided by the service providing server 200. This can improve user convenience.

In a case in which the association information including the identification information is stored in the HDD 115, the MFP 100 confirms whether the authentication success information associated with the identification information by the association information is valid. In a case in which it is confirmed that the authentication success information is valid, the MFP 100 sets the operation state to the operable state. Therefore, after the association information is stored, it is not necessary for the user to input the authentication information required for authentication for logging into the service to the MFP 100. Further, it is not necessary to store such authentication information in the MFP 100. Further, because it is confirmed whether the authentication success information is valid at a point in time at which the identification information of the user is input, it is possible to confirm whether a log-in to the service is permitted at a point in time at which the identification information is input. This enables authentication with high accuracy while facilitating a user operation.

Further, in response to reception of the identification information of the user in a period during which the inoperable state is set, the MFP 100 confirms whether the authentication success information associated with the input identification information by the association information is valid. Therefore, because whether authentication success information is valid is confirmed each time identification information of a user is input, the operable state can be set with respect to an operation performed by only a user who is permitted to log into a service at a point in time at which the identification information is input.

The MFP 100 may confirm whether authentication success information is valid at predetermined time intervals instead of confirming whether authentication success information is valid each time identification information of a user is input. For example, in a case in which a login to a service provided by the service providing server 200 continues for a predetermined period of time, etc., authentication success information is valid at least for a predetermined period of time. In such a case, it is sufficient that validity can be confirmed at least once in a predetermined period during which a log-in to a service provided by the service providing server 200 is valid. It is possible to set the operation state to the operable state respect to an operation of only a user who is permitted to log into a service at a point in time at which identification information is input by confirming whether authentication success information is valid at predetermined time intervals.

Further, the MFP 100 requests the service providing server 200 that has transmitted authentication success information to determine whether the authentication success information is valid. Therefore, it is possible to accurately confirm that a user is permitted to log into a service provided by the service providing server 200. In a case in which a login to a service provided by the service providing server 200 is authenticated by the authentication server, the MFP 100 may request the authentication server to determine whether authentication success information is valid.

Further, the MFP 100 confirms whether authentication success information is valid by confirming whether a communication session used for reception of the authentication success information is valid. Because a communication session established with the service providing server 200 is continued in a period during which a login to a service provided by the service providing server 200 is permitted, it is possible to accurately confirm that a user is permitted to log into the service by determining whether the communication session is valid. In a case in which a login to a service provided by the service providing server 200 is authenticated by the authentication server, the MFP 100 confirms whether a communication session used for reception of authentication success information from the authentication server is valid.

Further, in a case in which it is confirmed that authentication success information is not valid, the MFP 100 deletes association information including the authentication success information, and requires a user to input authentication information for logging into a service provided by the service providing server 200. Then, in response to acquisition of new authentication success information from the service providing server 200 based on the authentication information received from the user in response to the requirement, the MFP 100 stores association information that associates the new authentication success information with identification information. Therefore, the operation state can be set to the operable state with respect to an operation of only a user who is permitted to log into a service provided by the service providing server 200.

The MFP 100 in the modified example transfers association information including identification information and authentication success information to another MFP 100A. Therefore, in a case in which the identification information is input to the MFP 100A after the association information is transferred, it is possible to cause the service providing server 200 to provide a service.

Further, the MFP 100 in the modified example transfers association information in response to a requirement from the MFP 100A. Thus, because it is not necessary to transmit the association information to a device that has not require the association information, an increase in communication traffic can be prevented.

Further, the MFP 100 in the modified example transfers association information to the MFP 100A which is predetermined. Therefore, because the transfer destination of the association information is limited, security can be enhanced.

Further, in a case in which identification information that is accepted in a period during which the inoperable state is set is not associated with authentication success information, the MFP 100 in the modified example requires the other MFP 100A to transmit authentication success information associated with the identification information. Therefore, because the association information stored in the other MFP 100A is acquired, the MFP 100 can cause the service providing server 200 to provide a service without authentication in the service providing server 200.

### Second Embodiment

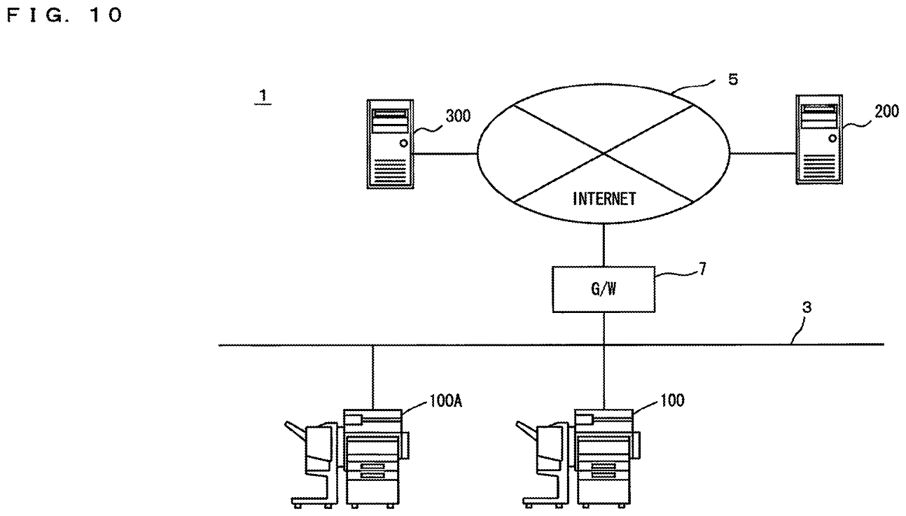

FIG. 10 is a diagram showing one example of the overview of an information processing system according to a second embodiment. With reference to FIG. 10, a difference from the information processing system 1 shown in FIG. 1 is that a management server 300 is added. The other configurations are the same as the configurations of the information processing system shown in FIG. 1. Therefore, a description thereof will not be repeated here.

The management server 300 is connected to the Internet 5. The management server 300 can communicate with the service providing server 200 via the Internet 5 and can communicate with MFPs 100,100A via the Internet 5 and the LAN 3.

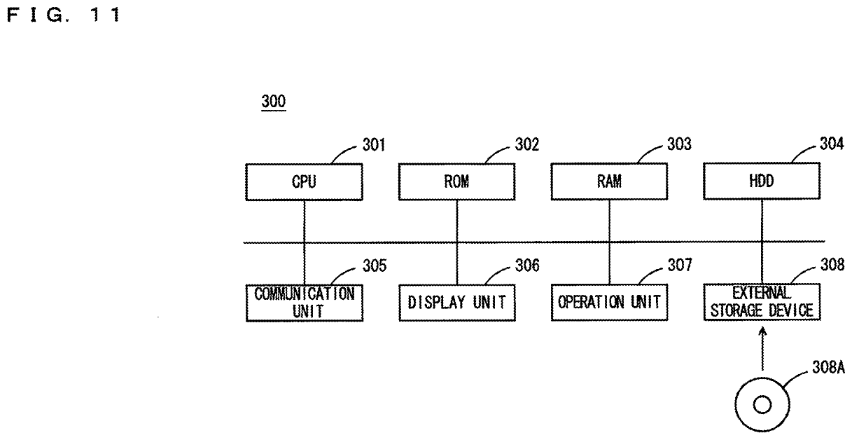

FIG. 11 is a block diagram showing one example of the overview of the hardware configuration of the management server in the second embodiment. With reference to FIG. 11, the management server 300 includes a Central Processing Unit (CPU) 301 for controlling the management server 300 as a whole, a ROM 302 for storing a server authentication program to be executed by the CPU 301, a RAM 303 used as a work area for the CPU 301, a HDD 304 for storing data in a non-volatile manner, a communication unit 305 for connecting the CPU 301 to the Internet 5, a display unit 306 for displaying information, an operation unit 307 for accepting input of a user operation and an external storage device 308 on which a CD-ROM 308A is mounted.

The CD-ROM 308A storing the server authentication program can be mounted on the external storage device 308. The CPU 301 can access the CD-ROM 308A via the external storage device 308. The CPU 301 can load the server authentication program recorded in the CD-ROM 308A mounted on the external storage device 308 into the RAM 303 for execution.

A medium for storing a program to be executed by the CPU 301 is not limited to the CD-ROM 308A and may be an optical disc, an IC card, an optical card or a semiconductor memory.

Further, a program to be executed by the CPU 301 is not limited to a program recorded in the CD-ROM 308A, and the CPU 301 may load a program stored in the HDD 304 into the RAM 303 for execution. In this case, another computer connected to the Internet 5 may rewrite a program stored in the HDD 304 of the management server 300 or may additionally write a new program therein. Further, the management server 300 may download a program from another computer connected to the Internet 5 and store the program in the HDD 304. The program referred to here includes not only a program directly executable by the CPU 301 but also a source program, a compressed program, an encrypted program and the like.

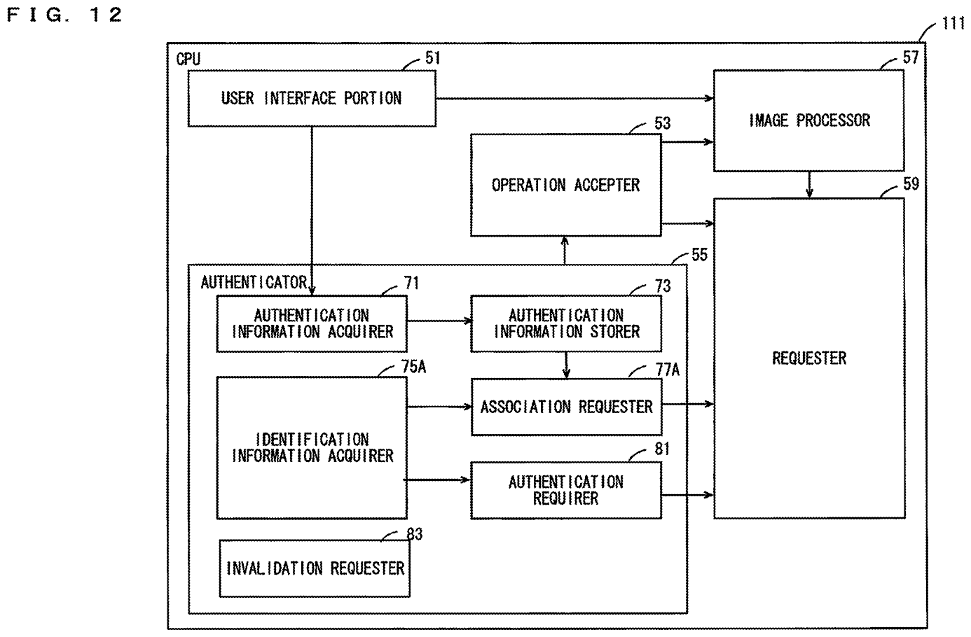

FIG. 12 is a diagram showing one example of the functions of a CPU included in an MFP in the second embodiment. The functions shown in FIG. 12 are different from the functions shown in FIG. 3 in that the identification information acquirer 75 and the associator 77 are changed to an identification information acquirer 75A and an association requester 77A, an authentication requirer 81 and an invalidation requester 83 are added, and the confirmer 79 is deleted. The other functions are the same as the functions shown in FIG. 3. A description therefore will not be repeated.

In the MFP 100 in the second embodiment, an authentication process executed by the authenticator 55 includes three types of authentication processes: a first authentication process, a second authentication process and a third authentication process. When authentication is successful in any one of the first authentication process, the second authentication process and the third authentication process, the authenticator 55 sets the operation state to an operable state.

The authenticator 55 includes the authentication information acquirer 71, the authentication information storer 73, the identification information acquirer 75A, the association requester 77A, the authentication requirer 81 and the invalidation requester 83. The authentication information acquirer 71 executes the first authentication process.

The identification information acquirer 75A acquires identification information input by a user. In a case in which identification information is acquired by the identification information acquirer 75, the authenticator 55 executes the second authentication process or the third authentication process based on the identification information. In a case in which authentication of a user is successful when the second authentication process or the third authentication process is executed, the authenticator 55 sets the operation state of the MFP 100 to the operable state.

In a case in which authentication success information is stored in the RAM 114 which is a recording medium by the authentication information storer 73 at a point in time at which identification information is acquired, the identification information acquirer 75A outputs the identification information to the association requester 77A. In a case in which authentication success information is not stored in the RAM 114 which is a recording medium by the authentication information storer 73 at a point in time at which identification information is acquired, the identification information acquirer 75A outputs the identification information to the authentication requirer 81.

In response to the input of identification information, the association requester 77A requests the management server 300 to perform association. For example, the association requester 77A controls the communication I/F unit 112 to transmit an association request command to the management server 300. The association request command includes identification information and authentication success information. The management server 300 which is a transmission destination of the association request command is registered in advance in the MFP 100. In response to reception of the association request command, the management server 300 generates association information including the identification information and the authentication success information, and stores the association information in a recording medium. The association information may include the identification information, and authentication-success-information identification information for identifying the authentication success information.

The authentication requirer 81 requires the management server 300 to perform authentication in response to receiving identification information from the identification information acquirer 75A. Specifically, the authentication requirer 81 controls the communication I/F unit 112 to transmit an authentication requirement command to the management server 300. The authentication requirement command includes identification information received from the identification information acquirer 75A. In response to receiving the authentication requirement command, the management server 300 determines whether authentication success information associated with the identification information included in the authentication requirement command is present. In a case in which association information including the same identification information as the identification information included in the authentication requirement command is stored, the management server 300 returns authentication success information included in the association information. However, if such association information is not stored, the management server 300 returns an error signal. In a case in which receiving the authentication success information from the management server 300, the authentication requirer 81 stores the authentication success information in the RAM 114.

In a case in which receiving identification information from the identification information acquirer 75A, the authenticator 55 executes the second authentication process or the third authentication process. In a case in which authentication success information is received from the management server 300 after the authentication requirer 81 transmits an authentication requirement command to the management server 300, the authenticator 55 executes the third authentication process of authenticating a user. In the third authentication process, in a case in which an error signal is received from the authentication requirer, user authentication is not performed.

In a case in which an error signal is received from the authentication requirer after the authentication requirer 81 transmits an authentication requirement command to the management server 300, the authenticator 55 executes the second authentication process. The second authentication process is a process of authenticating a user in a case in which the same identification information as the identification information acquired by the identification information acquirer 75 is stored in the MFP 100 in advance, and not authenticating the user in a case in which the same identification information as the identification information acquired by the identification information acquirer 75 is not stored in the MFP 100 in advance. Although setting the operation state of the MFP 100 to the operable state in a case in which the second authentication process is executed and the user is authenticated, the authenticator 55 sets the operation state of the MFP 100 to the inoperable state in a case in which the second authentication process is executed and the user is not authenticated.

In a case in which authentication success information is invalidated, the invalidation requester 83 transmits an invalidation request command to the management server 300 in order to invalidate association information including the authentication success information. The invalidation requester 83 determines that authentication success information is invalid in a case in which a user logs out from a service provided by the service providing server 200 or a case in which the service providing server 200 does not execute a process, which the requester 59 requests the service providing server 200 using the authentication success information to execute. The invalidation request command includes at least one of identification information and authentication success information. In response to receiving the invalidation request command, the management server 300 deletes the association information including the identification information or the authentication success information included in the invalidation request command.

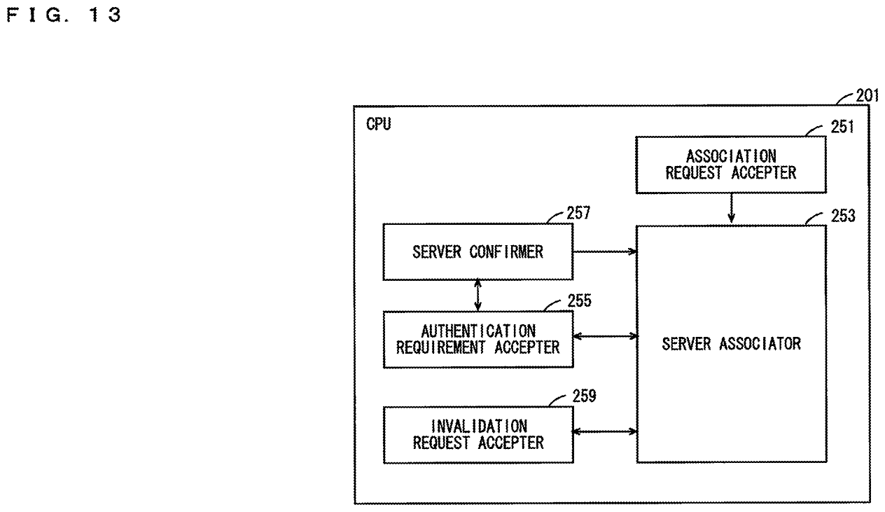

FIG. 13 is a block diagram showing one example of the functions of the CPU included in the management server in the second embodiment. The functions shown in FIG. 13 are implemented by the CPU 301 when the CPU 301 included in the management server 300 executes a server authentication program stored in the ROM 302, the RAM 303, the HDD 304 or the CD-ROM 308A. The server authentication program is part of the authentication program. With reference to FIG. 13, the CPU 301 included in the management server 300 includes an association request accepter 251, a server associator 253, an authentication requirement accepter 255, a server confirmer 257 and an invalidation request accepter 259.

The association request accepter 251 accepts an association request transmitted by either of the MFPs 100, 100A. The association request accepter 251 controls the communication unit 305 to receive an association request command from either of the MFPs 100, 100A. Here, the association request command is received from the MFP 100, by way of example. In response to receiving the association request command, the association request accepter 251 outputs identification information and authentication success information included in the association request command to the server associator 253.

In response to receiving the identification information and the authentication success information, the server associator 253 generates association information including the identification information and the authentication success information, and stores the association information in a recording medium. Here, the server associator 253 stores the association information in the HDD 304. The association information may include identification information, and authentication-success-information identification information for identifying authentication success information. The authentication-success-information identification information is the information representing a position where the authentication success information is stored.

The authentication requirement accepter 255 receives an authentication requirement from either of the MFPs 100, 100A. The authentication requirement accepter 255 controls the communication unit 305 to receive an authentication requirement command from either of the MFPs 100, 100A. Here, the authentication requirement command is received from the MFP 100, by way of example. In response to receiving the authentication requirement command, the authentication requirement accepter 255 performs authentication based on the identification information included in the authentication requirement command. In response to receiving the authentication requirement command, the authentication requirement accepter 255 determines whether authentication success information associated with the identification information included in the authentication requirement command is present. The authentication requirement accepter 255 determines whether the association information including the identification information included in the authentication requirement command is present in the association information stored in the HDD 115 by the server associator 253. In a case in which such association information is stored in the HDD 115, the authentication requirement accepter 255 outputs the authentication success information to the server confirmer 257 in order to request the server confirmer 257 to confirm validity of the authentication success information included in the association information.

In a case in which receiving the authentication success information from the authentication requirement accepter 255, the server confirmer 257 confirms whether the authentication success information is valid. Specifically, the server confirmer 257 requests the service providing server 200 that has transmitted the authentication success information to determine whether the authentication success information is valid. The server confirmer 257 accesses the service providing server 200 using the authentication success information, for example. In a case in which the authentication success information is valid, the service providing server 200 returns a response to accept access. In a case in which the authentication success information is not valid, the service providing server 200 returns a response to reject access. As described above, the authentication success information is valid only in a period during which the user is logged into a service in the service providing server 200. The server confirmer 257 confirms whether the authentication success information is valid based on the response of the service providing server 200. The server confirmer 257 outputs a result of determination in regard to whether the authentication success information is valid to the authentication requirement accepter 255. In a case in which determining that the authentication success information is not valid, the server confirmer 257 outputs an invalidation instruction to the server associator 253. The invalidation instruction includes the authentication success information received from the authentication requirement accepter 255.

After transmitting the authentication success information to the server confirmer 257, the authentication requirement accepter 255 receives a result of authentication from the server confirmer 257. In a case in which the result of authentication indicates that the authentication success information is valid, the authentication requirement accepter 255 returns the authentication success information to the MFP 100 that has transmitted the authentication requirement command. In a case in which the result of authentication indicates that the authentication success information is not valid, the authentication requirement accepter 255 returns an error signal to the MFP 100 that has transmitted the authentication requirement command.

The invalidation request accepter 259 receives an invalidation request from either of the MFPs 100, 100A. The invalidation request accepter 259 controls the communication unit 305 to receive an invalidation request command from either of the MFPs 100, 100A. Here, the invalidation request command is received from the MFP 100, by way of example. In response to receiving the invalidation request command, the invalidation request accepter 259 invalidates authentication success information based on identification information or authentication success information included in the invalidation request command. Specifically, the invalidation request accepter 259 outputs an invalidation instruction to the server associator 253. The invalidation instruction includes the identification information or the authentication success information included in the invalidation request command.

In a case in which receiving the invalidation instruction from the invalidation request accepter 259, the server associator 253 deletes the association information including the identification information or the authentication success information included in the invalidation instruction from the HDD 304.

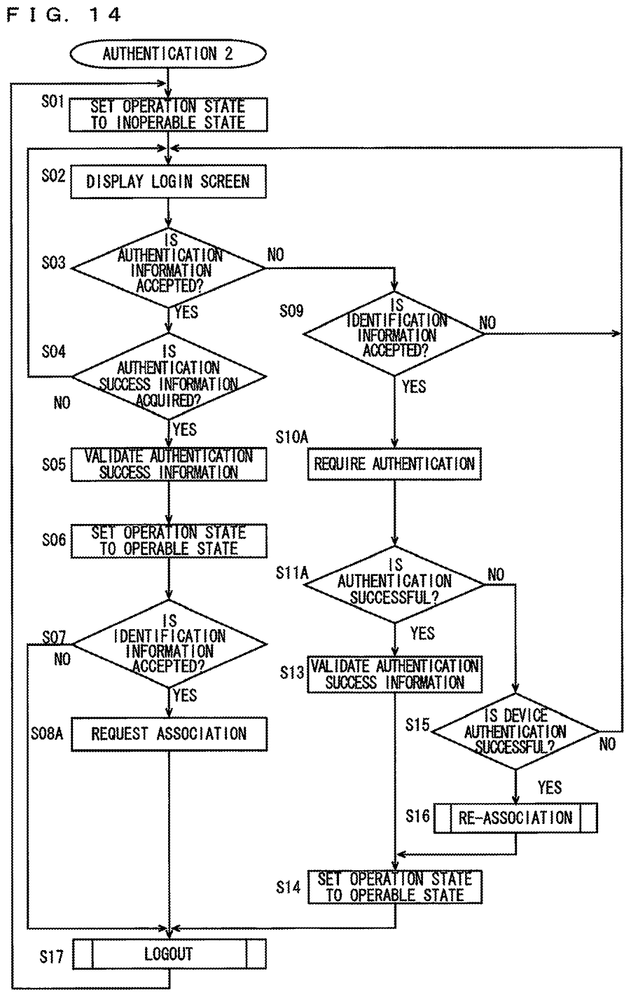

FIG. 14 is a flowchart showing one example of a flow of an authentication process in the second embodiment. The authentication process in the second embodiment differs from the authentication process in the first embodiment shown in FIG. 4 in that the step S08 is changed to the step S08A, and the steps S10 to S12 are changed to the step S10A and the step S11A. The other processes are the same as the processes shown in FIG. 4. Therefore, a description thereof will not be repeated here.

In the step S08A, the association between identification information and authentication success information is requested, and the process proceeds to the step S09. The management server 300 is requested to associate the authentication success information acquired in the step S03 with the identification information accepted in the step S07. Specifically, an association request command is transmitted to the management server 300 via the communication I/F unit 112. The association request command includes identification information and authentication success information.

In a case in which the identification information is accepted in the step S09, the process proceeds to the step S10A. In the step S10A, authentication with use of the identification information accepted in the step S09 is required. The management server 300 is requested to perform authentication with use of the identification information. Specifically, an authentication requirement command is transmitted to the management server 300 via the communication I/F unit 112. The authentication requirement command includes the identification information.

In the step S11A, whether authentication performed by the management server 300 has been successful is determined. In a case in which the communication I/F unit 112 receives authentication success information from the management server 300, it is determined that the authentication has been successful, and the process proceeds to the step S13. In a case in which the communication I/F unit 112 receives an error signal from the management server 300, it is determined that the authentication has failed, and the process proceeds to the step S15.

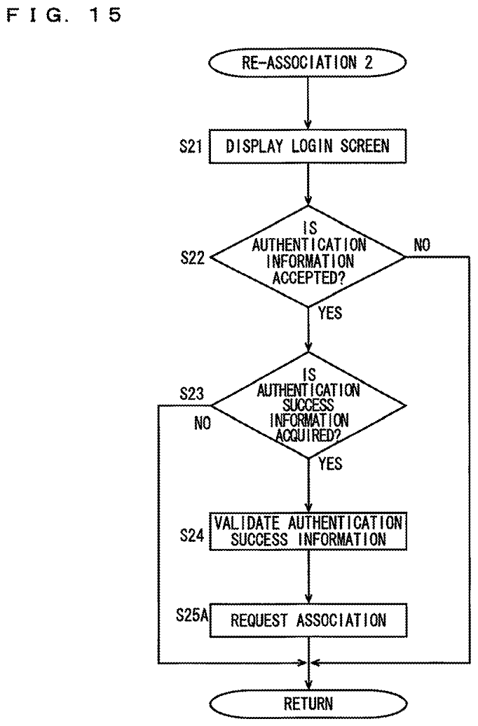

FIG. 15 is a flowchart showing one example of a flow of a re-association process in the second embodiment. The re-association process in the second embodiment is a process executed in the step S16 of the authentication process in the second embodiment. With reference to FIG. 15, the difference from the re-association process in the first embodiment shown in FIG. 5 is that the step S25 is changed to the step S25A. The other processes are the same as the processes those shown in FIG. 5. Therefore, a description thereof will not be repeated here. In the step S25A, the management server 300 is requested to associate the identification information accepted in the step S09 of the authentication process with the authentication success information accepted in the step S22. Specifically, an association request command is transmitted to the management server 300 via the communication I/F unit 112. The association request command includes the identification information and the authentication success information.

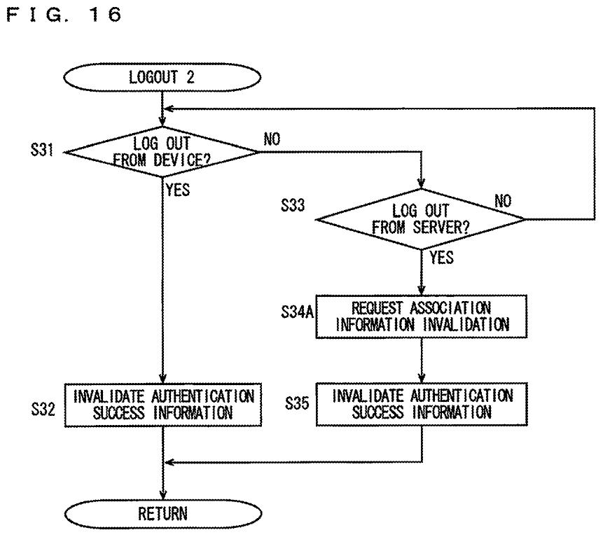

FIG. 16 is a flowchart showing one example of a flow of a logout process in the second embodiment. The logout process in the second embodiment is a process executed in the step S17 of the authentication process in the second embodiment. With reference to FIG. 16, the difference from the logout process in the first embodiment shown in FIG. 6 is that the step S34 is changed to the step S34A. The other processes are the same as the logout process in the first embodiment. Therefore, a description thereof will not be repeated here. In the step S34A, invalidation of the association information is requested. The CPU 111 requests the management server 300 to invalidate authentication success information stored in the RAM 114 in the management server 300. Specifically, an invalidation request command is transmitted to the management server 300 via the communication I/F unit 112. The invalidation request command includes the authentication success information.

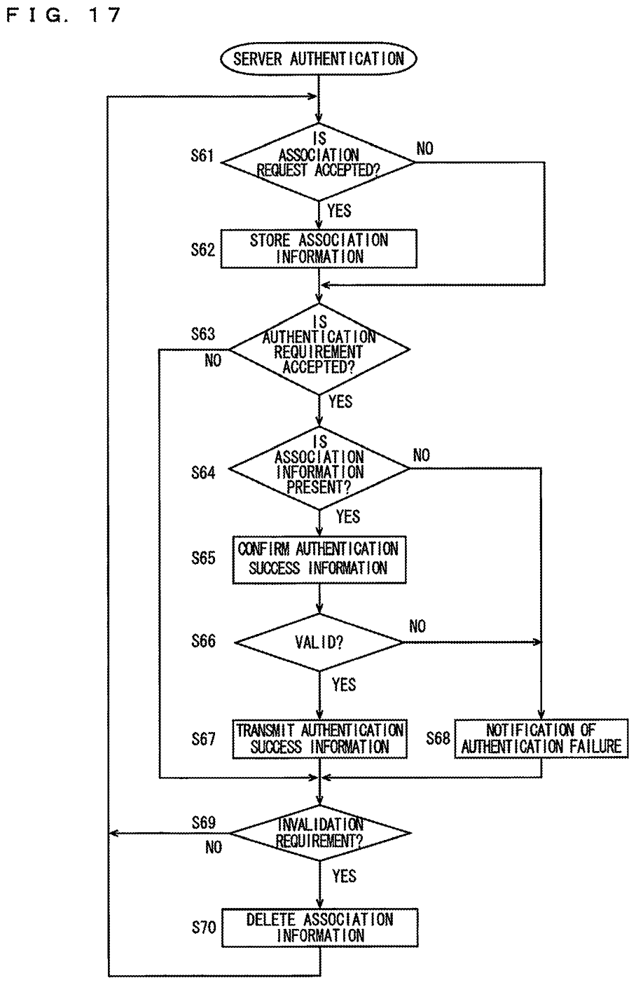

FIG. 17 is a flowchart showing one example of a flow of a server authentication process in the second embodiment. The server authentication process is a process executed by the CPU 301 when the CPU 301 included in the management server 300 in the second embodiment executes a server authentication program stored in the ROM 302, the RAM 303, the HDD 304 or the CD-ROM 308A. With reference to FIG. 17, the CPU 301 included in the management server 300 determines whether an association request has been accepted from either of the MFPs 100, 100A (step S61). In a case in which the communication unit 305 receives an association request command from either of the MFPs 100, 100A, the CPU 301 accepts the association request. If the association request is accepted, the process proceeds to the step S62. If not, the process skips the step S62 and proceeds to the step S63. Here, the association request command is received from the MFP 100, by way of example.

In the step S62, association information is stored, and the process proceeds to the step S63. Association information including identification information and authentication success information included in the association request command is generated to be stored in a recording medium. Here, the association information is stored in the HDD 304. The association information may include the identification information, and authentication-success-information identification information for identifying the authentication success information. The authentication-success-information identification information is the information representing a position where the authentication success information is stored.

In the step S63, whether an authentication requirement has been accepted from either of the MFPs 100, 100A is determined. In a case in which the communication unit 305 receives an authentication requirement command from either of the MFPs 100, 100A, the authentication requirement is accepted. If the authentication requirement has been accepted, the process proceeds to the step S64. If not, the process proceeds to the step S69. Here, the authentication requirement command is received from the MFP 100, by way of example.

In the step S64, whether the association information including the identification information included in the authentication requirement command is present is determined. If the association information including the identification information included in the authentication requirement command is stored in the HDD 304, the process proceeds to the step S65. If not, the process proceeds to the step S68. In the step S65, validity of the authentication success information included in the association information including the identification information included in the authentication requirement command is confirmed. For example, the CPU 301 requests the service providing server 200 that has transmitted the authentication success information to determine whether the authentication success information is valid. More specifically, the CPU 301 accesses the service providing server 200 using the authentication success information. As described above, the authentication success information is valid only in a period during which the user is logged into a service in the service providing server 200. The CPU 301 confirms whether the authentication success information is valid based on a response of the service providing server 200.

In the step S66, the process branches depending on whether the authentication success information is valid. If the authentication success information is valid, the process proceeds to the step S67. If not, the process proceeds to the step S68. The authentication success information is transmitted to the device that has transmitted the authentication requirement which is the MFP 100 in this case in the step S67, and the process proceeds to the step S69. In the step 68, the device that has transmitted the authentication requirement, which is the MFP 100 in this case, is notified of authentication failure, and the process proceeds to the step S69. For example, notification of the authentication failure includes transmission of an error signal.

In the step S69, whether an invalidation request has been accepted from either of the MFPs 100, 100A is determined. If the communication unit 305 receives an invalidation request command from either of the MFPs 100, 100A, the CPU 301 accepts the invalidation request. Here, the invalidation request command is received from the MFP 100, by way of example. If the communication unit 305 receives the invalidation request command from the MFP 100, the process proceeds to the step S70. If not, the process returns to the step S61. The invalidation request command includes identification information or authentication success information. In the step S70, association information is deleted based on the invalidation request command, and the process returns to the step S61. The association information including the identification information or the authentication success information included in the invalidation request command is deleted from the HDD 304.

In the information processing system 1 in the second embodiment, the MFP 100 functions as an image processing apparatus, requests the management server 300 to associate identification information that is accepted in a period during which the operable state is set with authentication success information, requires the management server 300 to perform authentication based on the identification information accepted in a period during which the inoperable state is set, and sets the operation state to the operable state in response to acquisition of the authentication success information associated with the identification information from the management server 300 in response to the authentication requirement with respect to the management server 300. Therefore, because the identification information and the authentication success information are associated with each other in the management server 300, it is possible to share the association between the identification information and the authentication success information with another image processing apparatus which is the MFP 100A, for example. Further, the MFP 100 requires the management server 300 to perform authentication based on the identification information accepted in a period during which the inoperable state is set, and sets the operation state to the operable state in response to acquisition of authentication success information from the management server 300 in response to the requirement. Therefore, after the MFP 100A requests the management server 300 to associate identification information with authentication success information, for example, the association can be utilized in the MFP 100.

Further, in a case in which authentication based on identification information fails in the management server 300 in response to a requirement for authentication with respect to the management server 300, the MFP 100 requires a user to transmit authentication information for logging into a service. In a case in which authentication success information is acquired based on the authentication information input by the user in response to the requirement, the MFP 100 requests the management server 300 to associate the authentication success information with the identification information. Therefore, in a case where a login to a service is not permitted at a transmission source of authentication success information, new authentication success information is acquired based on authentication information input by the user, and identification information of the user and the new authentication success information are associated with each other in the management server 300. Therefore, the operable state can be set with respect to an operation of only a user who is permitted to log into a service.

Further, the management server 300 transmits authentication success information to the service providing server 200 in order to cause the service providing server 200 to provide a service. Therefore, a login to a service can be confirmed reliably.

Further, the MFP 100 deletes authentication success information from the RAM 114 in response to the change from the operable state to the inoperable state. Therefore, after a login to a service is not permitted, it is possible to prevent the operation state from being set to the operable state.

Further, in the information processing system 1, an authentication token or an authorization token is used as authentication success information. Therefore, a login to a service can be confirmed easily.

Further, the management server 300 associates identification information with authentication success information in response to a request from either of the MFPs 100, 100A, and transmits authentication success information associated with identification information in response to a requirement from either of the MFPs 100, 100A. Therefore, it is possible to cause the management server 300 to work with the MFPs 100, 100A and confirm a login to a service in each of the MFPs 100, 100A. Further, it is possible to confirm a login to a service in each of the plurality of MFPs 100, 100A.

Further, the management server 300 confirms whether authentication success information associated with identification information is valid, and cancels association information including authentication success information that has been confirmed to be invalid and identification information. Therefore, each of the MFPs 100, 100A can be prevented from being set to the operable state with a login to a service provided by the service providing server 200 disabled.

### <Overview of Embodiments>

(Item 1) An image processing apparatus that is communicable with a service providing server that provides a service, includes a hardware-processor, wherein the hardware-processor acquires authentication success information representing a successful login to the service in response to an operation input by a user, executes an image process, and sets an operation state to an operable state in which an operation for executing the image process is acceptable in accordance with the authentication success information in response to acquisition of the authentication success information. According to this aspect, the authentication success information representing a successful login to a service is acquired in response to an operation input by a user, and the image processing apparatus is set to an operable state in which an operation for executing an image process is acceptable is set in accordance with the authentication success information in response to acquisition of the authentication success information. Therefore, the successful login to the service provided by the server enables execution of the image process. As a result, because authentication for executing the image process is not required, it is possible to provide the image processing apparatus that facilitates a user operation for authentication.

(Item 2) The image processing apparatus according to item 1, wherein the hardware-processor accepts input of identification information for identifying a user, associates the identification information accepted in a period during which the operable state is set with the authentication success information, and sets an operation state to the operable state in a case in which the identification information that is accepted in a period during which an inoperable state that is not the operable state is set is associated with the authentication success information. According to this aspect, the identification information accepted in a period during which an operable state is set is associated with authentication success information. Further, in a case in which the identification information accepted in a period during which an inoperable state is set is associated with authentication success information, the operation state is set to the operable state. Therefore, after the user inputs identification information in a period during which the operable state is set based on authentication information, in a case in which the user inputs the identification information in a period during which an inoperable state is set, the operation state is set to the operable state, and a server can provide a service. This can improve user convenience.

(Item 3) The image processing apparatus according to item 2, wherein the hardware-processor confirms whether the authentication success information is valid at a point in time at which the identification information is accepted. According to this aspect, whether the authentication identification information that is associated with identification information at a point in time at which the identification information is input by a user is valid is confirmed. Further, in a case in which it is confirmed that the authentication success information associated with the input identification information is valid, the operation state is set to the operable state. Therefore, because whether the authentication success information is valid is confirmed at a point in time at which the identification information of the user is input, whether a login to a service is permitted can be confirmed at the point in time at which the identification information is input. As a result, it is possible to provide an image processing apparatus capable of performing highly accurate authentication while facilitating a user operation.

(Item 4) The image processing apparatus according to item 3, wherein the hardware-processor confirms whether the authentication success information is valid in response to input of the identification information in a period during which the inoperable state is set. According to this aspect, whether authentication success information is valid is confirmed each time identification information of a user is input. Therefore, an operable state can be set with respect to an operation of only a user who is permitted to log into a service at a point in time at which identification information is input.

(Item 5) The image processing apparatus according to item 3 or 4, wherein the hardware-processor confirms whether the authentication success information is valid at predetermined time intervals. According to this aspect, whether authentication success information is valid is confirmed at predetermined time intervals. Therefore, in a case in which authentication success information is valid for at least a predetermined period of time, an operable state can be set with respect to an operation of only a user who is permitted to log into a service at a point in time at which identification information is input.

(Item 6) The image processing apparatus according to any one of items 3 to 5, wherein the hardware-processor requests a transmission source to determine whether the authentication success information is valid. According to this aspect, because whether authentication success information is valid is determined by a transmission source of the authentication success information, it is possible to accurately confirm that a user is permitted to log into a service.

(Item 7) The image processing apparatus according to any one of items 3 to 6, wherein the hardware-processor confirms whether a communication session used for communication for acquisition of the authentication success information with a transmission source of the authentication success information is valid. According to this aspect, because a communication session established with a transmission source of authentication success information is continued in a period during which a login to a service is permitted at the transmission source, it is possible to accurately confirm that a user is permitted to log into the service by determining whether the communication session is valid.

(Item 8) The image processing apparatus according to any one of items 3 to 7, wherein the hardware-processor requires a user to input authentication information for logging into the service in a case in which it is confirmed that the authentication success information is not valid, and associates the authentication success information acquired based on the authentication information input by the user in response to the requirement with the identification information. According to this aspect, in a case in which a login to a service is no longer permitted at a transmission source of authentication success information, new authentication success information is acquired based on authentication information input by a user, and the identification information of the user and the new authentication success information are associated with each other. Therefore, an operable state can be set with respect to an operation of only a user who is permitted to log into a service.

(Item 9) The image processing apparatus according to any one of items 2 to 8, wherein the hardware-processor transfers a set of the identification information and the authentication success information that are associated with each other to another image processing apparatus. According to this aspect, it is possible to cause a server to provide a service by inputting identification information to another image processing apparatus.

(Item 10) The image processing apparatus according to item 9, wherein the hardware-processor transfers the set of the identification information and the authentication success information in response to a requirement from the another image processing apparatus. According to this aspect, because it is not necessary to transmit a set of identification information and authentication success information to a device that does not require the set, an increase in communication traffic can be prevented.

(Item 11) The image processing apparatus according to item 9 or 10, wherein the another image processing apparatus is a predetermined apparatus. According to this aspect, because a set of identification information and authentication success information is transmitted to a predetermined device, security can be enhanced.

(Item 12) The image processing apparatus according to any one of items 2 to 11, wherein the hardware-processor requires another image processing apparatus to transmit the authentication success information associated with the identification information in a case in which the identification information that is accepted in a period during which the inoperable state is set is not associated with the authentication success information. According to this aspect, because the authentication success information associated with the identification information stored in another apparatus is acquired, it is possible to cause the service providing server to provide a service without performing an operation of logging into the service.

(Item 13) The image processing apparatus according to item 1, wherein the hardware-processor accepts identification information of a user, requests a management server to associate the identification information that is accepted in a period during which the operable state is set with the authentication success information, requires the management server to perform authentication based on the identification information that is accepted in a period during which an inoperable state that is not the operable state is set, and sets an operation state to the operable state in response to acquisition of the authentication success information associated with the identification information from the management server in response to the requirement.

According to this aspect, because a management server associates identification information and authentication success information to each other, it is possible to share the association between the identification information and the authentication success information with another image processing apparatus. Further, the management server is required to perform authentication based on the identification information that is accepted in a period during which an inoperable state, that is not an operable state, is set, and the operation state is set to the operable state in response to acquisition of authentication success information from the management server in response to the requirement. Therefore, after the management server is requested to perform the association between identification information and authentication success information in another image processing apparatus, the association can be utilized. As a result, it is possible to cause the server to provide a service without performing an operation of logging into a service provided by the server.

(Item 14) The image processing apparatus according to item 13, wherein the hardware-processor requires a user to input authentication information for logging into the service in a case in which authentication based on the identification information in the management server in response to the requirement fails, and requests the management server to associate the authentication success information acquired based on the authentication information input by a user in response to the requirement with the identification information. According to this aspect, in a case where a login to a service is not permitted at a transmission source of authentication success information, new authentication success information is acquired based on authentication information input by a user, and identification information of the user and new authentication success information are associated with each other in a management server. Therefore, an operable state can be set with respect to an operation of only a user who is permitted to log into a service.

(Item 15) The image processing apparatus according to any one of items 1 to 14, wherein the hardware-processor transmits the authentication success information to the service providing server in order to cause the service providing server to provide the service.

(Item 16) The image processing apparatus according to any one of items 1 to 15, wherein the hardware-processor deletes the authentication success information in response to a change from the operable state to an inoperable state that is not the operable state. According to this aspect, an operation state can be prevented from being set to an operable state with the service providing server not being able to log into a service.

(Item 17) The image processing apparatus according to any one of items 1 to 16, wherein the hardware-processor deletes the authentication success information in response to a change from the operable state to an inoperable state that is not the operable state. According to this aspect, it is possible to easily confirm a login to a service.

(Item 18) An information processing system is an information processing system including the image processing apparatus according to item 13 or 14 and the management server, and the management server includes a server hardware-processor, wherein the server hardware-processor associates the identification information with the authentication success information in response to a request from the image processing apparatus, and transmits the authentication success information associated with the identification information to the image processing apparatus in response to a requirement from the image processing apparatus. According to this aspect, it is possible to cause the management server to work with an image processing apparatus and confirm a login to a service in the image processing apparatus. Further, it is possible to confirm a login to a service in each of the plurality of image processing apparatuses. As a result, it is possible to provide an information processing system that facilitates a user operation for authentication.

(Item 19) The information processing system according to item 18, wherein the server hardware-processor confirms whether the authentication success information associated with the identification information is valid, and cancels association between the authentication success information that has been confirmed to be not valid and the identification information. According to this aspect, an image processing apparatus can be prevented from being set to an operable state while not being able to log into a service provided by the service providing server.

(Item 20) An authentication method that is executed in an image processing apparatus communicable with a server that provides a service, includes acquiring authentication success information representing a successful login to the service in response to an operation input by a user, an image processing step of executing an image process, and setting an operation state to an operable state in which an operation for executing the image process is acceptable in accordance with the authentication success information in response to acquisition of the authentication success information. According to this aspect, it is possible to provide an authentication method that facilitates a user operation for authentication.

(Item 21) A non-transitory computer-readable recording medium is encoded with an authentication program executed in a computer that controls an image processing apparatus communicable with a server that provides a service, and the authentication program causes the computer to acquire authentication success information representing a successful login to the service in response to an operation input by a user, execute an image process, and set an operation state to an operable state in which an operation for executing the image process is acceptable in accordance with the authentication success information in response to acquisition of the authentication success information. According to this aspect, it is possible to provide an authentication program facilitates a user operation for authentication.

(Item 22) The image processing apparatus according to any one of items 2 to 15 further includes an identification information reader that reads medium identification information stored in a recording medium assigned to a user, wherein the identification information accepter accepts the medium identification information as the identification information in response to the medium identification information being read by the identification information reader.

(Item 23) The image processing apparatus according to any one of items 2 to 15 further includes a biometric information reader that reads biometric information of a user, wherein the identification information accepter accepts the biometric information as the identification information in response to the biometric information being read by the biometric information reader.

(Item 24) The image processing apparatus according to any one of items 2 to 15 further includes a code accepter that accepts a code assigned to a user, wherein the identification information accepter accepts the code as the identification information in response to acceptance of the code by the code accepter.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image processing apparatus that is communicable with a service providing server that provides a service, comprising a hardware-processor,
wherein
the hardware-processor
acquires authentication success information representing a successful login to the service in response to an operation input by a user,
executes an image process, and
sets an operation state to an operable state in which an operation for executing the image process is acceptable in accordance with the authentication success information in response to acquisition of the authentication success information.

2. The image processing apparatus according to claim 1, wherein
the hardware-processor
accepts input of identification information for identifying a user,
associates the identification information accepted in a period during which the operable state is set with the authentication success information, and
sets an operation state to the operable state in a case in which the identification information that is accepted in a period during which an inoperable state that is not the operable state is set is associated with the authentication success information.

3. The image processing apparatus according to claim 2, wherein
the hardware-processor confirms whether the authentication success information is valid at a point in time at which the identification information is accepted.

4. The image processing apparatus according to claim 3, wherein
the hardware-processor confirms whether the authentication success information is valid in response to input of the identification information in a period during which the inoperable state is set.

5. The image processing apparatus according to claim 3, wherein
the hardware-processor confirms whether the authentication success information is valid at predetermined time intervals.

6. The image processing apparatus according to claim 3, wherein
the hardware-processor requests a transmission source to determine whether the authentication success information is valid.

7. The image processing apparatus according to claim 3, wherein
the hardware-processor confirms whether a communication session used for communication for acquisition of the authentication success information with a transmission source of the authentication success information is valid.

8. The image processing apparatus according to claim 3, wherein
the hardware-processor
requires a user to input authentication information for logging into the service in a case in which it is confirmed that the authentication success information is not valid, and
associates the authentication success information acquired based on the authentication information input by the user in response to the requirement with the identification information.

9. The image processing apparatus according to claim 2, wherein
the hardware-processor transfers a set of the identification information and the authentication success information that are associated with each other to another image processing apparatus.

10. The image processing apparatus according to claim 9, wherein
the hardware-processor transfers the set of the identification information and the authentication success information in response to a requirement from the another image processing apparatus.

11. The image processing apparatus according to claim 9, wherein
the another image processing apparatus is a predetermined apparatus.

12. The image processing apparatus according to claim 2, wherein
the hardware-processor requires another image processing apparatus to transmit the authentication success information associated with the identification information in a case in which the identification information that is accepted in a period during which the inoperable state is set is not associated with the authentication success information.

13. The image processing apparatus according to claim 1, wherein
the hardware-processor
accepts identification information of a user,
requests a management server to associate the identification information that is accepted in a period during which the operable state is set with the authentication success information,
requires the management server to perform authentication based on the identification information that is accepted in a period during which an inoperable state that is not the operable state is set, and
sets an operation state to the operable state in response to acquisition of the authentication success information associated with the identification information from the management server in response to the requirement.

14. The image processing apparatus according to claim 13, wherein
the hardware-processor
requires a user to input authentication information for logging into the service in a case in which authentication based on the identification information in the management server in response to the requirement fails, and
requests the management server to associate the authentication success information acquired based on the authentication information input by a user in response to the requirement with the identification information.

15. The image processing apparatus according to claim 1, wherein
the hardware-processor transmits the authentication success information to the service providing server in order to cause the service providing server to provide the service.

16. The image processing apparatus according to claim 1, wherein
the hardware-processor deletes the authentication success information in response to a change from the operable state to an inoperable state that is not the operable state.

17. The image processing apparatus according to claim 1, wherein
the authentication success information is an authentication token or an authorization token.

18. An information processing system is an information processing system including the image processing apparatus according to claim 13 and the management server,
the management server comprising a server hardware-processor, wherein
the server hardware-processor
associates the identification information with the authentication success information in response to a request from the image processing apparatus, and
transmits the authentication success information associated with the identification information to the image processing apparatus in response to a requirement from the image processing apparatus.

19. The information processing system according to claim 18, wherein
the server hardware-processor
confirms whether the authentication success information associated with the identification information is valid, and
cancels association between the authentication success information that has been confirmed to be not valid and the identification information.

20. An authentication method that is executed in an image processing apparatus communicable with a server that provides a service, including:
acquiring authentication success information representing a successful login to the service in response to an operation input by a user;
executing an image process; and
setting an operation state to an operable state in which an operation for executing the image process is acceptable in accordance with the authentication success information in response to acquisition of the authentication success information.

21. A non-transitory computer-readable recording medium encoded with an authentication program executed in a computer that controls an image processing apparatus communicable with a server that provides a service,
the authentication program causing the computer to
acquire authentication success information representing a successful login to the service in response to an operation input by a user;
execute an image process; and
set an operation state to an operable state in which an operation for executing the image process is acceptable in accordance with the authentication success information in response to acquisition of the authentication success information.
